(19) United States
(12) Patent Application Publication
(10) Pub. No.: US 2007/0137255 A1
(43) Pub. Date: Jun. 21, 2007

(54) Optical device and method of manufacturing the optical same

(76) Inventors: Taisei Miyake, Tokyo (JP); Susumu Ohneda, Kanagawa (JP); Keiko Shiraishi, Kanagawa (JP); Hirckazu Takeuchi, Shiga (JP); Nobuo Funabiki, Shiga (JP); Ryo Nagase, Tokyo (JP); Shuichi Yanagi, Tokyo (JP); Shinichi Iwano, Tokyo (JP)

Correspondence Address: J C PATENTS, INC., 4 VENTURE, SUITE 250, IRVINE, CA, 92618, US

(21) Appl. No.: 10/502,878

(22) PCT Filed: Jan. 28, 2003
(86) PCT No.: PCT/JP03/00759

§ 371 Date: Jan. 5, 2005

(30) Foreign Application Priority Data
Jan. 29, 2002 (JP) 2002-20338
May 21, 2002 (JP) 2002-146354

(51) Int. Cl. C03B 37/022; C03C 21/00; C03B 37/027

(52) U.S. Cl. 65/393; 65/400

(57) ABSTRACT

A method of manufacturing an incorporated ferrule (13) with attenuation optical fiber comprising the step of cutting off a long capillary with an attenuation optical fiber (6) into a plurality of short capillaries (12) with attenuation optical fiber of specified lengths, and polishing the end faces (12a) and (12b) of the short capillaries (12) with attenuation optical fiber.

### BACKGROUND OF THE INVENTION

The present invention relates to an optical device for use in the fields of optical communication, optical measurement, CATV system, etc. and a method of manufacturing the same.

Generally speaking, in constructing an optical fiber communication network, an optical device using a functional optical fiber having various functions is employed. For example, a large number of optical fibers are connected to a switchboard, etc. of an optical fiber communication network by means of an optical connector. A plurality of optical signals connected to such a switchboard or the like greatly differ in optical signal intensity in the optical fibers due to a difference in the lengths of the optical fibers and due to prior optical signal processing. Thus, to process these optical fibers in a similar fashion by a switchboard or the like, it is necessary for the intensities of the optical signals in the connected optical fibers to be matched within a predetermined range. For this matching of optical signal intensities, there is utilized an optical device (optical fixed attenuator) using an attenuation optical fiber as a functional optical fiber.

The above-mentioned optical fixed attenuator has a basic construction in which connection to an optical connector is effected by means of a ferrule into which there is inserted an optical fiber attenuating an optical signal by a predetermined intensity value (hereinafter referred to as the attenuation optical fiber) and a sleeve partially retaining this ferrule and retaining a ferrule of another optical connector inserted therein. A structure in which an attenuation optical fiber thus serves as an optical signal attenuation mechanism is referred to as a ferrule with an attenuation optical fiber. The ferrule used here is manufactured in the same manner as one used in an optical connector, thereby ensuring the requisite dimensional accuracy.

Various methods will be available as the optical signal attenuation means of an optical fixed attenuator of such a construction; in particular, attention is being focused on a means using an attenuation optical fiber with optical attenuation dopant added thereto because of its high. performance, high reliability, low cost, etc.

For example, JP 10-39145 A discloses an SC type optical fixed attenuator as shown in FIGS. 6(A) and 6(B); in the drawings, reference numeral 1 indicates an attenuation optical fiber, reference numeral 2 indicates a ferrule with an attenuation optical fiber, reference numeral 4 indicates a casing, and reference numeral 5 indicates a split sleeve formed of zirconia. FIG. 6(C) shows the construction of the ferrule 2 with an attenuation optical fiber; in the drawing, reference numeral 3 indicates a ferrule formed of zirconia.

The ferrule 2 with an attenuation optical fiber has a simple construction formed by simply fixing the attenuation optical fiber 1 through adhesion in the ferrule 3 and then polishing the end surfaces for connection. A working precision on the order of sub micron is required of the ferrule 3 used here, so that it is general practice to mold and fire zirconia and then achieve the requisite precision through cutting.

Regarding the precision for an optical connector ferrule generally used, what is important are the outer diameter of the connection end (one end), the inner diameter of the inner hole for the optical fiber, and eccentricity of the inner hole; the precision of the inner diameter of the inner hole at the other end, the inner hole eccentricity, etc. are not so important. When the inner hole precision for the optical fiber is actually ensured at the ends of the optical connector, the yield is reduced substantially, resulting in high cost.

However, as shown in FIG. 6(A), the above optical attenuator has a construction in which connection to optical connectors is effected at both ends of the ferrule 2 with an attenuation optical fiber, so that, as shown in FIG. 6(C), the ferrule 3 used therein is longer than the optical connector ferrule; further, it is necessary to ensure outer diameter precision and eccentricity precision of the inner hole for the optical fiber at both ends, so that the production yield is reduced substantially as compared with ordinary optical connector ferrules, resulting in high cost.

As stated above, such conventional optical attenuator ferrules are longer than ordinary optical connector ferrules on the market, and use a special ferrule in which inner hole precision at both ends is ensured, so that the production amount of such conventional ferrules is far smaller than that of ordinary optical connector ferrules, and are produced as so-called customized products, with the result that their price is higher than that of ordinary optical connector ferrules by not less than one digit. As a result, the price of these special-spec ferrules constitutes a factor obstructing a reduction in the price of optical fixed attenuators.

As compared with a zirconia ferrule, a crystallized glass ferrule for optical connectors is less expensive, and can be continuously formed by drawing, so that little increase in price is involved if increased in length. However, even in the case of a crystallized glass ferrule, if formed in a configuration as shown in FIG. 6 (C), there is no flared portion guiding the optical fiber to facilitate its insertion into the inner hole, so that, when a ferrule with an attenuation optical fiber is to be assembled by using this ferrule, it is necessary to perform the difficult operations of pouring adhesive into the inner hole with a diameter slightly larger than that of the attenuation optical fiber, carefully inserting the attenuation optical fiber while observing it by a microscope, and uniformly filling the gap between the inner hole and the attenuation optical fiber with adhesive so that no bubbles, etc. may not be generated therein. Thus, a high-skill operation is required; further, since the assembly capacity is in proportion to the number of workers, a rather high cost is involved.

Further, while in the inner hole of a crystallized glass ferrule, a fresh surface with no stain is obtained with high accuracy when forming the preform by drawing, the interior of the inner hole is stained by cutting fluid, abrasive, and glass powder by the subsequent cutting and C-beveling, so that it is absolutely necessary to inspect the inner diameter of the inner hole. This inspection is effected by pass through inspection using a pin gage; in this case also, the insertion of the pin gage takes time due to the absence of a flared portion.

Further, in a ferrule of the configuration as shown in FIG. 6(C), when fixing the attenuation optical fiber by adhesive, a collection of adhesive is positively formed on end surfaces to be subjected to PC polishing in order to facilitate the PC polishing of the attenuation optical fiber end surfaces; however, when the outer diameter of the ferrule is Φ1.25 mm, the area of the end surface portions is small, so that adhesive is allowed to intrude upon the C-beveling portion, and the adhesive thus clinging to the C-beveling portion has to be scraped off after PC polishing by means of a cutter knife or the like, resulting in an increase in processing man-hours, which leads to a reduction in yield.

Further, when a ceramic capillary is used as the ferrule, and an attenuation optical fiber is fixed in the inner hole, the thermal expansion coefficient of the attenuation optical fiber, which is formed of silica glass, is approximately 5×10⁻⁷/K, whereas the thermal expansion coefficient of the ceramic capillary is as large as 8.3×10⁻⁶/K, so that the phenomenon of the end surfaces of attenuation optical fiber situated at the ferrule end surfaces protruding or retracting from or into them as a result of changes in temperature occurs to a large degree. When, as a result of this phenomenon, the end surfaces of PC-connected optical fibers are separated from each other, reflection light is generated, so that a connection quality providing the requisite return loss cannot be obtained. Thus, in order that the end surfaces of the PC-connected optical fibers may not be separated from each other, it is necessary to control the fiber retraction amount at the ferrule end surfaces after polishing so as to keep it not more than 50 nm.

Further, when a ceramic ferrule is used, and an attenuation optical fiber is fixed in the inner hole thereof, the ceramic ferrule allows transmission of substantially no light with a wavelength ranging from 350 nm to 500 nm, at which a photo-curing adhesive is generally cured. Thus, this structure has a problem in that it is impossible to use a photo-curing adhesive sensitive to light from ultraviolet rays to blue visible light.

Further, when a ceramic ferrule is used, and an attenuation optical fiber is fixed in the inner hole thereof, the ceramic ferrule allows transmission of substantially no light of 1000 nm or more, so that it is impossible to perform defect inspection, etc. using a laser beam or the like within an infrared range of 1000 nm or more, on a capillary with an attenuation optical fiber, into which an attenuation optical fiber is inserted for fixation.

Similarly, also in a case in which some other functional optical fiber, such as fiber grating, is used, there is involved a problem in that the optical device is rather expensive.

### SUMMARY OF THE INVENTION

In view of the above problems in the prior art, it is an object of the present invention to provide an optical device manufacturing method making it possible to retain a functional optical fiber in a stable manner and prepare an optical device with a dramatically improved efficiency, and to provide an optical device to be obtained at low cost by this manufacturing method.

In order to achieve the above object, according to a construction of the present invention, there is provided a method including: forming a softened crystallized glass into a long capillary from which a plurality of short capillaries can be obtained; fixing a long functional optical fiber in an inner hole of the long capillary by an adhesive to prepare a long capillary with a functional optical fiber; cutting the long capillary with a functional optical fiber in a predetermined length to prepare a plurality of short capillaries with functional optical fibers; and polishing an end surface of each of the short capillaries with functional optical fibers. In this construction, the inner hole of the long capillary is not contaminated and the clean surface at the time of shaping is maintained, so that there is no need to perform pin gage inspection on the inner hole of the capillary, the operation of fixing the functional optical fiber in the inner hole of the capillary is greatly reduced, and there is no need to perform the process of scraping off the adhesive squeezed out, thus making it possible to substantially reduce the requisite assembly man-hours for an optical device.

In the above construction, when forming softened crystallized glass into a long capillary, it is possible to prepare a long capillary by performing drawing on a tubular preform precision-machined and consisting of crystallized glass, or it is possible to prepare a long capillary from molten crystallized glass by precision-shaping. This long capillary tube has an entire length that provides a plurality of short capillaries with functional optical fibers for use in a ferrule with a functional optical fiber; the plurality of short capillaries with functional optical fibers may be of the same length or of two or more different lengths.

For example, when the entire length of the long capillary is 40 mm or more, it is possible to obtain a plurality of short capillaries with functional optical fibers having an entire length of less than 20 mm. When the entire length of the long capillary is 400 mm or less, the inner hole can be filled with adhesive easily and uniformly, and heat treatment can be conducted in an existing heating furnace, which is desirable.

As the above-mentioned functional optical fiber, it is possible to adopt an attenuation optical fiber, fiber grating, etc. For example, when manufacturing an optical fixed attenuator by using an attenuation optical fiber, it is important that the transmission loss of an optical signal be a predetermined optical attenuation amount with the length after fixation in the ferrule and end surface finishing; thus, the attenuation optical fiber used is one controlled such that the optical attenuation amount per unit length is a value within a predetermined range. Further, it is only necessary for the long attenuation optical fiber fixed in the long capillary to be fixed by adhesion over substantially the entire length of the inner hole of the long capillary; there is no need for the attenuation optical fiber to be fixed so as to extend up to the forward end portion of the long capillary which is to be post-processed and removed later; further, there is no problem if the attenuation optical fiber protrudes to some degree from the end surface of the long capillary.

It is desirable that the above-described attenuation optical fiber is a single mode optical fiber whose optical attenuation characteristics with respect to optical signals of different wavelengths are substantially equalized by adding a dopant effecting attenuation to a degree in proportion to a wavelength of an optical signal into a mode field at a predetermined concentration, and by adjusting a mode field diameter substantially contributing to optical signal transmission. As the dopant added in the mode field, Co can be used,: for example.

Regarding such an attenuation optical fiber, the concentration distribution of Co added to the core portion and the mode field diameter are controlled such that the optical attenuation amount at different wavelengths of 1.31 μm band and 1.55 μm band are fixed, whereby it is possible to substantially equalize the optical attenuation characteristics with respect to optical signals of 1.31 μm band and 1.55 μm band.

Further, the above-described attenuation optical fiber may be one with a high refractive index dopant, which causes an increase in refractive index, added in a clad outer peripheral portion. It is desirable to use Ge as the high refractive index dopant, for example.

By adding Ge to the outer peripheral portion of the clad, the refractive index is increased, and the clad mode generated is trapped for absorption, whereby it is possible to prevent wavelength dependency with wavy optical attenuation amount attributable to the influence of the clad mode on an optical signal.

Further, it is desirable for the above-mentioned adhesive to exhibit an operational viscosity of not more than 1 Pa·s prior to operation, whereby, even if the inner hole of the long capillary has a small diameter of, for example, approximately 126 μm, it is possible to fill the inner hole easily with adhesive without involving generation of vacuum bubbles by pressure feed or evacuation from the end surface on the opposite side.

Further, it is desirable for at least one end surface of each of the above-mentioned short capillaries with functional optical fibers to be subjected to PC polishing. In the ferrule with an optical functional fiber of an optical device prepared by using such short capillaries with functional optical fibers, it is possible to prevent reflection of an optical signal through PC connection with an optical connector plug; further, the ferrule can be prepared more efficiently than in the prior art.

It is desirable for the long capillary to have a thermal expansion coefficient of less than 7×10⁻⁶/K. In the ferrule with a functional optical fiber or an optical device prepared by using short capillaries with functional optical fibers having such characteristics, there is no fear of the retained PC connection unfastening due to changes in temperature; it is possible to maintain the connection quality of the optical signal within a predetermined range. Further, the ferrule can be prepared more efficiently than in the prior art.

Further, it is desirable to form a compressive stress layer on the surface of the long capillary by quenching or ion exchange. By forming a compressive stress layer on the surface of the long capillary, an increase in mechanical strength is achieved, whereby, even if some flaws or the like are generated on the ferrule with a functional optical fiber of an optical device as a result of machining, no damage or chipping is caused when a heavy thermal shock or external force is applied at the time of handling, thus facilitating the handling.

In the case in which a compressive stress layer is formed by quenching on the surface of the long capillary, it is possible to increase the strength in a stable manner with substantially no variation although the degree of reinforcement is not so large.

In the case in which a compressive stress layer is formed by ion exchange on the surface of the long capillary, the degree of reinforcement is relatively large. Any crystallized glass containing ions of alkali elements, such as Li or Na, can be used for the long capillary to be subjected to ion exchange processing; a lithium-alumina-silicate system crystallized glass or the like is suitable.

Further, it is also possible to use a long capillary formed of a crystallized glass having a thickness of 1 mm and allowing transmission of 30% or more of light; having a wavelength ranging from 350 to 500 nm, and fix a functional optical fiber in the long capillary by filling the inner hole of the long capillary with a photo-curing adhesive, inserting the long functional optical fiber into the inner hole substantially over an entire length thereof, and then curing the photo-curing adhesive through exposure. This makes it possible to fix a long functional optical fiber in a short time, making it possible to substantially reduce the assembly time for the ferrule with a functional optical fiber of an optical device.

Further, it is also possible to use a long capillary having a thickness of 1 mm and a light transmissivity allowing transmission of 30% or more of light having a wavelength ranging from 800 nm to 2500 nm, apply light having a wavelength ranging from 800 nm to 2500 nm to the long capillary with a functional optical fiber, and observe light or image transmitted therethrough to inspect the functional optical fiber for an adhesion defect. This makes it possible to inspect the long capillary with a functional optical fiber easily in a non-contact manner.

Here, specifically speaking, the “ferrule with a functional optical fiber” connected to an optical connector consists of a crystallized glass; for example, it is equipped with an inner hole and an outer peripheral surface smith a dimensional accuracy equivalent to that of a cylindrical ferrule for optical connectors; ones with substantially the same sectional dimension can be connected through abutment in a cylinder superior in straightness; further, an optical connector with a special configuration, such as a bi-conical type, in which positioning through fitting is effected on a conical surface, is excluded.

As described above, in accordance with the manufacturing method of the present invention, it is possible to substantially reduce the requisite man-hours for preparing an optical device easily allowing abutment connection with an optical connector. Thus, the optical device of the present invention manufactured by this manufacturing method is inexpensive, which greatly contributes to a reduction in the price of an optical fixed attenuator, etc.

### BRIEF DESCRIPTION OF THE DRAWINGS

FIG. 1 illustrates an optical device manufacturing method, of which FIG. 1(A) is an explanatory view showing how crystallized glass is shaped by drawing, FIG. 1(B) is an explanatory view illustrating ion exchange processing, FIG. 1(C) is a diagram showing the state before ion exchange, and FIG. 1(D) is a diagram showing the state after ion exchange.

FIG. 2 illustrates how a flared portion for inserting a functional optical fiber is provided at an end of a long capillary, of which FIG. 2(A) is an explanatory view illustrating how a substantially conical flared portion is formed at an end of the long capillary tube by cutting with a tool obtained by firing diamond abrasive grains, FIG. 2(B) is an explanatory view showing how a capillary with a substantially conical flared portion at one end is inserted from one end of a split sleeve and how a long capillary is inserted from the other end thereof to provide a flared portion at an end of the long capillary, and FIG. 2(C) is an explanatory view showing how a substantially conical flared portion is formed by etching at an end of the long capillary.

FIG. 3 illustrates how an attenuation optical fiber is fixed to a long capillary, of which FIG. 3(A) is an explanatory view illustrating how the attenuation optical fiber is inserted into the long capillary filled with adhesive, FIG. 3(B) is an explanatory view illustrating how inspection is conducted on the adhesion condition and defect, FIG. 3(C) is an explanatory view illustrating how the adhesive is cured.

FIG. 4 is a sectional view of a long capillary with an attenuation optical fiber.

FIG. 5 illustrates how a ferrule with an attenuation optical fiber is prepared by using a long capillary with an attenuation optical fiber, of which FIG. 5(A) is an explanatory view of short capillaries with attenuation optical fibers obtained by cutting a long capillary with an attenuation optical fiber in predetermined lengths, FIG. 5(B) is an explanatory view of a capillary with an attenuation optical fiber with beveled end surfaces, and FIG. 5(C) is an explanatory view of a ferrule with an attenuation optical fiber.

FIG;. 6 shows an optical fixed attenuator, of which FIG. 6(A) is a sectional view thereof, FIG. 6(B) is an explanatory view of an end surface thereof, and FIG. 6(C) is an explanatory view of a ferrule with an attenuation optical fiber.

### DESCRIPTION OF PREFERRED EMBODIMENTS

In the following, embodiments of the present invention will be described.

First, preforms formed of crystallized glasses of the compositions as shown in Table 1 are prepared.

TABLE 1

| | | Sample No. | | | | |
|---|---|---|---|---|---|---|
| | | 1 | 2 | 3 | 4 | 5 |
| Glass | SiO₂ | 57.8 | 66.3 | 67.4 | 64.3 | 65.9 |
| composition | Al₂O₃ | 24.6 | 18.2 | 16.6 | 18.0 | 18.2 |
| (% by mass) | Li₂O | 2.7 | 2.3 | 2.3 | 2.5 | 2.0 |
| | K₂O | 7.0 | 3.4 | 3.5 | 5.0 | 3.4 |
| | TiO₂ | 2.8 | 1.8 | 3.0 | 3.0 | 1.5 |
| | ZrO₂ | 3.2 | 1.8 | 1.8 | 2.0 | 1.8 |
| | ZnO | 1.0 | 3.1 | 2.0 | 3.1 | 3.6 |
| | MgO | — | 1.0 | 1.0 | 1.0 | 1.5 |
| | CaO | — | — | — | 0.4 | 0.6 |
| | BaO | — | — | — | 0.5 | 1.4 |
| | B₂O₃ | — | — | 2.0 | — | — |
| | Na₂O | 0.4 | — | — | — | — |
| | P₂O₅ | — | — | 0.4 | — | — |
| | As₂O₃ | 0.5 | — | — | 0.2 | 0.1 |
| | Bi₂O₃ | — | 2.1 | — | — | +113 |

| | | | | | |
|---|---|---|---|---|---|
| Crystallizing | 780 | 780 | 790 | 780 | 780 |
| condition (° C.) | | | | | |
| nucleus formation | | | | | |
| temperature | | | | | |
| Crystal growth | 1000 | 1000 | 980 | 1050 | 1000 |
| temperature | | | | | |
| Main crystal | β-quartz | β- | β- | β- | β- |
| | solid | spodumene | spodumene | spodumene | spodumene |
| | solution | solid | solid | solid | solid |
| | | solution | solution | solution | solution |

The crystallized glasses used for the preforms are ones having a thermal expansion coefficient of 2.7×10⁻⁶/K, a Vickers hardness of 680 kg/mm², and a thickness of 1 mm, and transmitting light with a wavelength ranging from 800 nm to 2500 nm by approximately 30%.

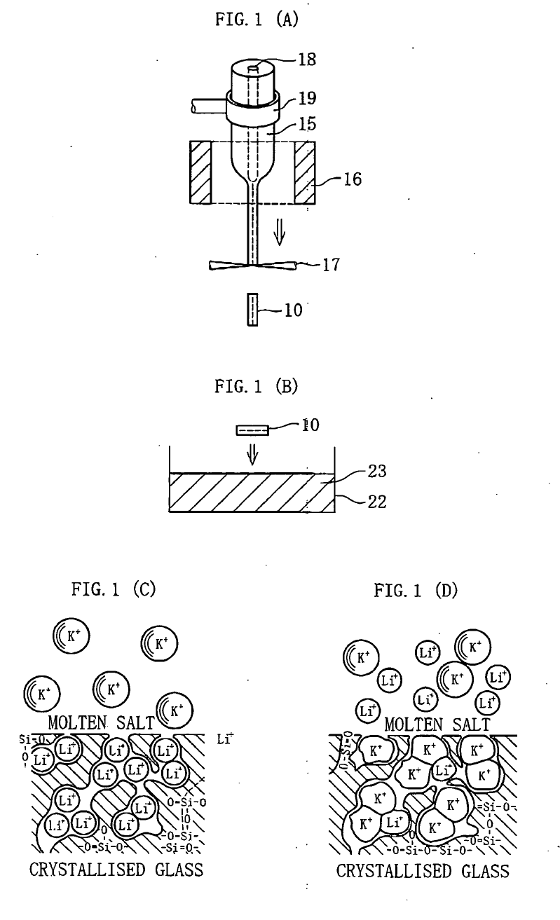

FIG. 1 illustrates drawing and ion exchange performed on crystallized glass. When a long capillary is to be prepared, there is prepared first, as shown in FIG. 1(A), a preform 15 of crystallized glass having at its center hole 18. Next, the preform 15 is mounted to a drawing device 19, and heated by an electric furnace 16; the drawing preform extracted from the furnace is pulled by a drive roller (not shown), and drawn into a crystallized glass capillary 10 with an inner hole while adjusting it to a predetermined sectional dimension and configuration. After this drawing, the capillary is cut in a length of approximately 250 mm by a cutter 17.

When a compressive stress layer is to be formed on the surface of the long capillary by quenching, cold air or refrigerant is blown against the crystallized glass capillary 10 with a predetermined sectional dimension and configuration coming out of the furnace for quenching, thereby generating a compressive stress layer on the glass surface.

Next, as shown in FIG. 1(B), when reinforcement is to be effected by ion exchange, the crystallized glass capillary 10 having a length of approximately 250 mm is immersed in KNO₃ molten salt 23 in an ion exchange vessel 22 maintained at approximately 400° C. for approximately 10 hours. Thereafter, the KNO₃ is removed by washing and a capillary is obtained whose three-point bending strength as mechanical strength has been increased by two times or more as compared with that of one which has undergone no such processing. In this ion exchange processing, the glass in the state as shown in FIG. 1(C) is turned into the state as shown in FIG. 1(D) by replacing the alkali ions (Li⁺) by alkali ions with a larger diameter (K⁺) at a lower temperature than annealing temperature, whereby a strong compressive stress layer is formed on the glass surface to thereby achieve an increase in practical strength. This provides the following advantages: (1) it is possible to obtain a strength two times or more of that in the case of air blast cooling; (2) there are no limitations regarding configuration and wall thickness; (3) it is possible to achieve a high dimensional accuracy since no deformation is involved; (4) even a small specimen piece difficult to retain can be subjected to the processing; (5) there is no fear of separation as in the case of a protective film; etc.

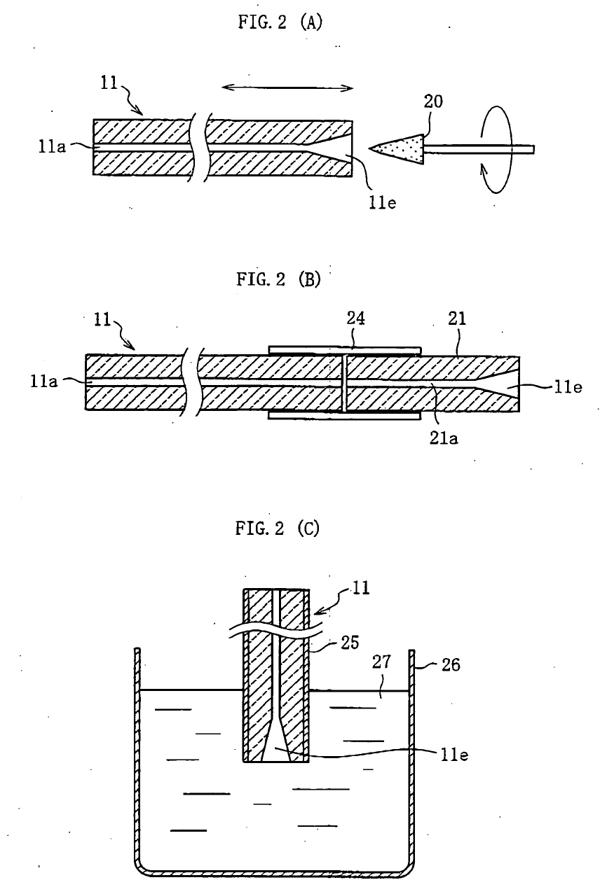

Next, as shown in FIG. 2(A), a tool 20 obtained by firing diamond abrasive grains and having a forward end angle of approximately 90° is rotated at high speed, and cutting is performed around an inner hole 11a from the end surface of a crystallized glass long capillary, whereby a substantially conical flared portion 11e is formed to thereby prepare a long capillary 11.

Alternatively, as shown in FIG. 2(B), an end portion of a crystallized glass long capillary and the other end of the capillary 21 with a substantially conical flared portion 11e are respectively forced in from the two ends of a split sleeve 24, and are caused to abut each other in the split sleeve 24 to align an inner hole 21a of the capillary 21 with the inner hole 11a of the long capillary 11, whereby the flared portion 11e is provided at an end of the long capillary 11.

Alternatively, as shown in FIG. 2(C), the outer surface of a crystallized glass long capillary is protected by a resin acid-resistant film 25, and an end portion of the capillary is immersed in a glass erosion solution 27 in an etching vessel 26, whereby the substantially conical flared portion 11e is formed at the end of the long capillary 11.

The long capillary 11 thus prepared has an outer diameter of 1.249 mm±0.5 μm and exhibits a high degree of circularity; the silica type optical fiber has a diameter of 125 μm, whereas the inner hole 11a has a diameter of 125.5 μm+1/−0 μm and a concentricity of not more than 1 μm; it is possible to accurately perform positioning for retention on the functional optical fiber with respect to a substantially cylindrical MU type or LC type optical connector ferrule having a nominal diameter D of 1.25 mm. At the end surface of the long capillary 11, there is formed the substantially conical flared portion 11e for guiding the functional optical fiber to facilitate its insertion.

In the following, by way of example, a case will be described in which the present invention is applied to an optical fixed attenuator using an attenuation optical fiber.

Control is performed on the concentration distribution of Co added to the core portion and mode field diameter so that the optical attenuation amount with respect to optical signals of 1.31 μm band and of 1.55 μm band may be fixed, and the clad outer peripheral portion is caused to contain Ge to increase the refractive index to trap clad mode for absorption, thus preparing a single-mode type long attenuation optical fiber 6. This attenuation optical fiber 6 is used as an optical fixed attenuator, and is adjusted to have a length of 16.6 mm and an optical attenuation amount of 10 dB.

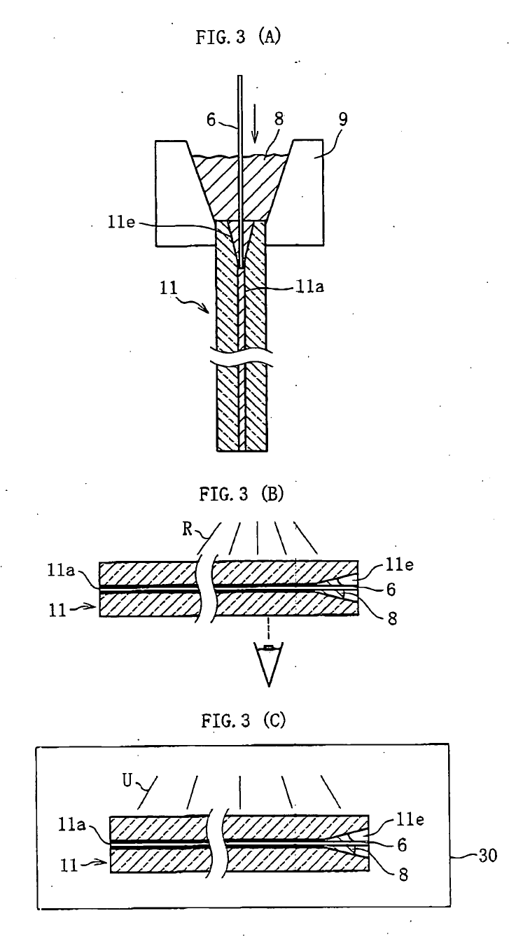

As shown in FIG. 3(A), the inner hole 11a of the prepared long capillary 11 is filled with adhesive 8, previously collected in an adhesive reservoir 9, by utilizing capillarity, or an evacuator or a pressure injection device, and then the attenuation optical fiber 6 with its coating removed is inserted from the flared portion 11e. At this time, while inserting the attenuation optical fiber 6, the gap between the inner hole 11a and the attenuation optical fiber 6 is uniformly filled with the adhesive 8 so as not to generate bubbles, etc. in the gap. In this process, when the viscosity of the adhesive 8 is 1 Pa·s or less, it is more difficult for bubbles, etc. tobe generated in the long capillary 11 at the time of insertion of the attenuation optical fiber 6. For example, when the adhesive EPO-TEK 330 manufactured by EPOXY TECHNOLOGY, Co. is used, the viscosity is 0.4 Pa·s (the data value in the catalog issued in 1997: Viscosity (mixed) @ 100 rpm/23° C. . . . 422 cPs), and the attenuation optical fiber 6 can be inserted without a hitch.

When the attenuation optical fiber 6 is to be directly inserted starting with the flared portion 11e, the insertion has to be performed carefully and slowly so that the attenuation optical fiber 6 may not be deflected during insertion.

After the filling with the adhesive 8, or during or after the insertion of the attenuation optical fiber 6, as shown in FIG. 3(B), light R with a wavelength of 800 to 2500 nm is applied from a light source (not shown) to the long capillary 11 formed of a crystallized glass having a thickness of 1 mm and transmitting 30% or more of light with a wavelength of 800 to 2500 nm and transmitted through the long capillary 11, and the transmitted light or transmitted image is observed in an enlarged state by an infrared camera, thereby performing inspection on the condition and defect of the adhesive 8 between the long capillary 11 and the attenuation optical fiber 6. Thereafter, the curing of the adhesive 8 is effected on the specimens proved acceptable, and the attenuation optical fiber 6 is fixed to the long capillary 11.

When fixing the attenuation optical fiber 6, if the long capillary 11 is formed of N−0 manufactured by Nippon Electric Glass, Co., Ltd., obtained through precipitation of a β-quartz solid solution crystal having a thickness of 1 mm and transmitting 30% or more of light with a wavelength of 350 nm to 500 nm to exhibit a thermal expansion coefficient of −6×10⁻⁷/K, as shown in FIG. 3(c) it is possible to use a photo-curing adhesive 8 having sensitivity to predetermined light from ultraviolet rays to blue visible light, so that, by applying ultraviolet rays U of approximately 350 nm, it is possible to fix the attenuation optical fiber 6 in a time as snort as several tens of seconds.

When the adhesive 8 is of the thermosetting type, as shown in FIG. 3(C), the adhesive 8 in the long capillary 11 is cured in a heating oven 30 programmed to a predetermined temperature schedule.

After the fixing of the attenuation optical fiber 6, as shown in FIG. 3 (B), light R with a wavelength of 800 to 2500 nm is applied from a light source (not shown) to the long capillary 11 formed of a crystallized glass having a thickness of 1 mm and transmitting 30% or more of light with a wavelength of 800 to 2500 nm and transmitted through the long capillary 11, and the transmitted light or transmitted image is observed in an enlarged state by a camera, thereby performing inspection on the condition and defect of the adhesive 8 between the long capillary 11 and the attenuation optical fiber 6.

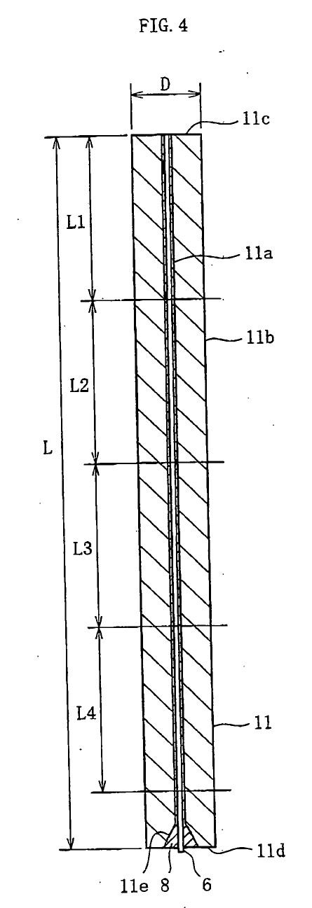

As shown in FIG. 4, the long capillary 11 with the attenuation optical fiber 6 inserted therein is equipped with the inner hole 11a and the outer peripheral surface 11b of a dimensional accuracy equivalent to that of a substantially cylindrical MU type or LC type optical connector ferrule having a nominal diameter D of 1.25 mm, and an entire length L thereof is one making it possible to obtain a plurality of short capillaries with attenuation optical fibers (having a length of L1, L2, L3, L4, etc.). This long capillary 11 has the entire length L, for example, of 250 mm, and an attenuation optical fiber 6 is inserted into the inner hole 11a thereof and fixed therein by the adhesive 8 of an epoxy type.

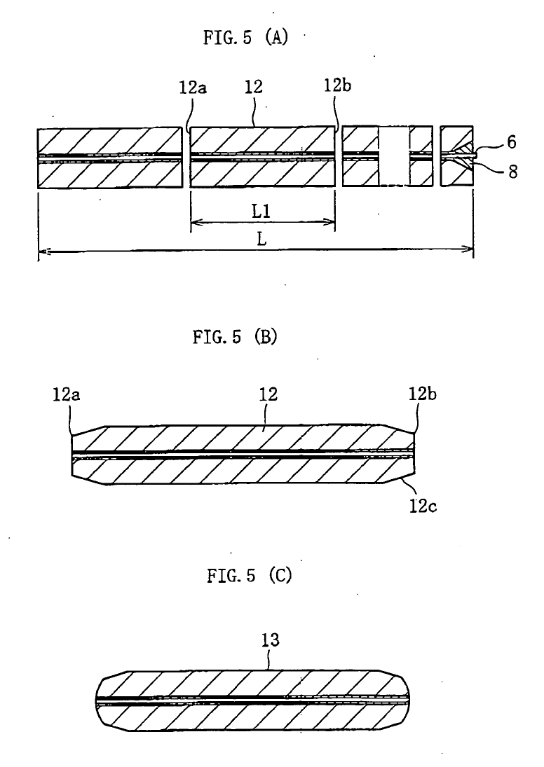

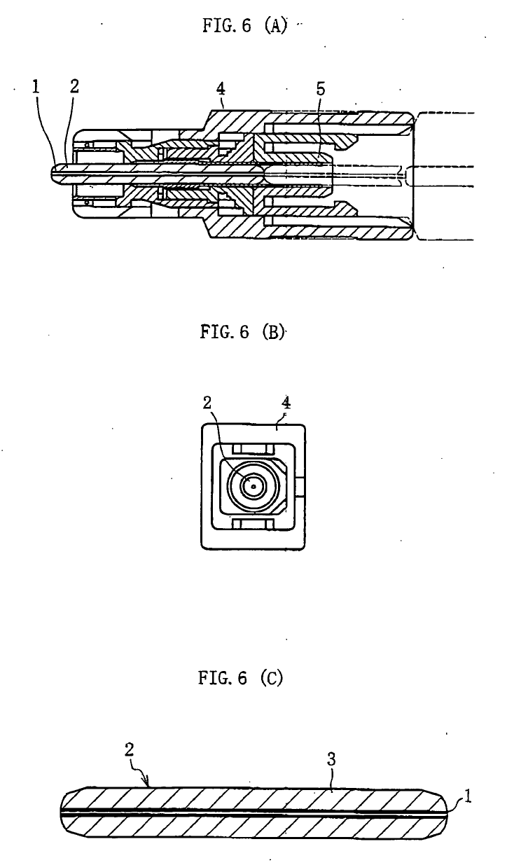

As shown in FIG. 5, when preparing a ferrule 13 with an attenuation optical fiber, the long capillary 11 with an attenuation optical fiber having an entire length of approximately 250 mm is cut into 13 short capillaries 12 with attenuation optical fibers each having a length L1 of 16.7 mm. Then, C-beveling at 45° as indicated at 12c is effected at end surfaces 12a and 12b of each short capillary 12 with an attenuation optical fiber, and the corner portions formed by the C-beveled portions 12c and the side surface are rounded. After the processing, the two end surfaces 12a and 12b are PC-polished into convex spherical surfaces, thereby preparing the ferrule 13 with an attenuation optical fiber.

The ferrule 13 with an attenuation optical fiber thus prepared is incorporated into a housing equipped with a member having a precision positioning function, such as a split sleeve or a receptacle, and forms, for example, an optical attenuator as shown in FIG. 6.

The diameter of the ferrule 13 with an attenuation optical fiber may also be other than 1.25 mm, for example, 2.5 mm.

The optical fixed attenuator thus prepared uses the long capillary 11 with the attenuation optical fiber 6 as the base material, so that it can be prepared more efficiently than in the prior art. Further, as the attenuation optical fiber 6, there is used a single mode optical fiber whose optical attenuation characteristics with respect to optical signals of different wavelengths are substantially equalized, whereby there is obtained an attenuation optical fiber suitable for use in wavelength multiplexing communication. Further, by using the ferrule 13 with an attenuation optical fiber whose end surfaces are PC-polished, high quality PC connection is possible. Further, by making the thermal expansion coefficient of the long capillary 11 constituting the base material 2.7×10⁻⁶/K, which is less than 7×10⁻⁶/K, there is generated, with a change in temperature, such as ambient temperature, no such variation as would adversely affect the intensity of the optical signal transmitted both the retained silica type attenuation optical fiber and the other optical component, making it possible to maintain the connection quality of the optical signal within a predetermined range. Further, by forming a compressive stress layer by quenching or ion exchange on the surface of the long capillary 11 constituting the base material, even if there are generated some flaws, etc. by machining, or even when violent thermal shock is applied or external force is applied during handling, no damage or chipping occurs, thus facilitating the handling. Further, as the long capillary 11 constituting the base material, there is used one having a thickness of 1 mm and adapted to transmit approximately 30% or more of light with a wavelength of 800 nm to 2500 nm, and the transmitted light or transmitted image is observed, whereby the attenuation optical fiber is inspected for adhesion defect, making it possible to maintain a high level of reliability. Further, as the long capillary 11 constituting the base material, there is used one having a thickness of 1 mm and adapted to transmit approximately 30% or more of light with a wavelength of 350 nm to 500 nm, and the adhesive is cured through exposure, whereby assembly can be effected efficiently in a short time.

As described above, according to the present invention, positioning can be effected accurately and in a stable manner on a functional optical fiber at a position where abutment connection with an optical fiber of an optical connector or the like is possible, making it possible to prepare an optical device of high reliability with substantially reduced man-hours and drastically improved efficiency as compared with the prior art.

Further, positioning can be performed accurately and in a stable manner on an attenuation optical fiber at a position where abutment connection with an optical fiber of an optical connector is possible, making it possible to prepare an optical fixed attenuator of high reliability using an attenuation optical fiber whose optical attenuation characteristics with respect to optical signals of different wavelengths are substantially equal, with substantially reduced man-hours and drastically improved efficiency as compared with the prior art.

In this way, the present invention provides a superior practical effect of making it possible to manufacture an optical device using a functional optical fiber at low cost. Further, an optical device manufactured by the manufacturing method of the present invention is inexpensive, which greatly contributes to a reduction in the price of an optical fixed attenuator, etc.

It should be noted that, by using a fiber grating as the functional optical fiber, it is also possible to manufacture an optical filter at low cost.

1. An optical device manufacturing method comprising:
forming a softened crystallized glass into a long capillary from which a plurality of short capillaries can be obtained;
fixing a long functional optical fiber in an inner hole of the long capillary by an adhesive to prepare a long capillary with a functional optical fiber;
cutting the long capillary with a functional optical fiber in a predetermined length to prepare a plurality of short capillaries with functional optical fibers; and
polishing an end surface of each of the short capillaries with functional optical fibers.

2. An optical device manufacturing method according to claim 1, wherein an attenuation optical fiber is used as the functional optical fiber.

3. An optical device manufacturing method according to claim 2, wherein the attenuation optical fiber is a single mode optical fiber whose optical attenuation characteristics with respect to optical signals of different wavelengths are substantially equalized by adding a dopant effecting attenuation to a degree in proportion to a wavelength of an optical signal into a mode field at a predetermined concentration, and by adjusting a mode field diameter substantially contributing to optical signal transmission.

4. An optical device manufacturing method according to claim 3, wherein the attenuation optical fiber is an attenuation optical fiber using Co as the dopant in the mode field.

5. An optical device manufacturing method according to claim 2, wherein the attenuation optical fiber is an attenuation optical fiber comprising a high refractive index dopant added in a clad outer peripheral portion, the high refractive index dopant causing an increase in refractive index.

6. An Optical device manufacturing method according to claim 5, wherein Ge is used as the high refractive index dopant.

7. An optical device manufacturing method according to claim 1, wherein the adhesive exhibits an operational viscosity of 1 Pa·s or less prior to curing.

8. An optical device manufacturing method according to claim 1, comprising PC-polishing at least one end surface of each of the short capillaries with functional optical fibers.

9. An optical device manufacturing method according to claim 1, wherein the long capillary has a thermal expansion coefficient of less than 7×10⁻⁶/K.

10. An optical device manufacturing method according to claim 1, comprising forming a compressive stress layer on a surface of the long capillary by quenching or ion exchange.

11. An optical device manufacturing method according to claim 1, wherein the long capillary is formed of a crystallized glass having a thickness of 1 mm and allowing transmission of 30% or more of light having a wavelength ranging from 350 to 500 nm, the method comprising filling the inner hole of the long capillary with a photo-curing adhesive, inserting the long functional optical fiber into the inner hole substantially over an entire length thereof, and then curing the photo-curing adhesive through exposure to fix the functional optical fiber in the inner hole of the long capillary.

12. An optical device manufacturing method according to claim 1, wherein the long capillary has a thickness of 1 mm and a light transmissivity allowing transmission of 30% or more of light having a wavelength ranging from 800 nm to 2500 nm, the method comprising applying light having a wavelength ranging from 800 nm to 2500 nm to the long capillary with a functional optical fiber and observing light or image transmitted therethrough to inspect the functional optical fiber for an adhesion defect.

13. An optical device which is manufactured by the optical device manufacturing method as claimed in claim 1 and which is connected to an optical connector.
